(19) United States
(12) Patent Application Publication
(10) Pub. No.: US 2026/0269428 A1
(43) Pub. Date: Sep. 10, 2026

(54) BUSBAR MODULE FOR TRACTION BATTERY PACK

(71) Applicant: Ford Global Technologies, LLC, Dearborn, MI (US)

(72) Inventors: Antony George Schepak, Howell, MI (US); Daniel Benjamin Kok, Ann Arbor, MI (US); Patrick Daniel Maguire, Ann Arbor, MI (US); Mohammadreza Eftekhari, Novi, MI (US); Deanna Marie Winton Hoffman, Ann Arbor, MI (US)

(21) Appl. No.: 19/304,671

(22) Filed: Aug. 20, 2025

Related U.S. Application Data
(60) Provisional application No. 63/766,671, filed on Mar. 4, 2025.

(51) Int. Cl. H01M 50/524; H01M 10/625; H01M 10/643; H01M 10/6557; H01M 50/213; H01M 50/249; H01M 50/289; H01M 50/526; H01M 50/569

(52) U.S. Cl. CPC H01M 50/524; H01M 10/625; H01M 10/643; H01M 10/6557; H01M 50/213; H01M 50/249; H01M 50/289; H01M 50/526; H01M 50/569

(57) ABSTRACT

A traction battery pack may include a housing. The traction battery pack may also include a plurality of battery cells arranged within the housing. Further, the traction battery pack may include a busbar configured to electrically connect the battery cells. The busbar may be partially embedded in a polymer material so as to provide an embedded busbar. The embedded busbar establishes at least a portion of the housing.

### RELATED APPLICATIONS

This application claims the benefit of U.S. Provisional Application No. 63/766,671, filed Mar. 4, 2025, the entirety of which is herein incorporated by reference.

### TECHNICAL FIELD

This disclosure relates generally to a busbar module of a traction battery pack of an electrified vehicle.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack, including: a housing; a plurality of battery cells arranged within the housing; and a busbar configured to electrically connect the battery cells, wherein the busbar is partially embedded in a polymer material so as to provide an embedded busbar, and wherein the embedded busbar establishes at least a portion of the housing.

In some aspects, the techniques described herein relate to a traction battery pack, further including: a first layer of polymer material adjacent the battery cells; and a second layer of polymer material, wherein the busbar is arranged between the first and second layers of polymer material.

In some aspects, the techniques described herein relate to a traction battery pack, further including: a sensing circuit, wherein the sensing circuit is also arranged between the first and second layers of polymer material.

In some aspects, the techniques described herein relate to a traction battery pack, wherein the sensing circuit is configured to sense a voltage of the battery cells.

In some aspects, the techniques described herein relate to a traction battery pack, wherein the sensing circuit is arranged between the busbar and the second layer of polymer material.

In some aspects, the techniques described herein relate to a traction battery pack, wherein: the first layer of polymer material includes a plurality of openings, the busbar includes a plurality of nodes, and each of the nodes is configured to project through one of the openings to electrically couple to one of the battery cells.

In some aspects, the techniques described herein relate to a traction battery pack, wherein the second layer of polymer material includes a plurality of openings aligned with the nodes to facilitate welding of the nodes to a corresponding one of the battery cells.

In some aspects, the techniques described herein relate to a traction battery pack, wherein: a terminal of the busbar projects through the second polymer layer.

In some aspects, the techniques described herein relate to a traction battery pack, wherein the first and second layers of polymer material directly contact one another outside a perimeter of the busbar to establish a fluid-tight seal adjacent the perimeter of the busbar.

In some aspects, the techniques described herein relate to a traction battery pack, further including: a fluid conduit arranged adjacent the battery cells, wherein the fluid conduit defines a passageway configured to guide thermal exchange fluid relative to the battery cells and prevents the thermal exchange fluid from coming into contact with the busbar.

In some aspects, the techniques described herein relate to a traction battery pack, further including: a plurality of sleeves, wherein each battery cell is arranged within one of the sleeves, and wherein the polymer material is coupled to the each of the sleeves so as to establish a plurality of fluid-tight barriers between thermal exchange fluid and the busbar.

In some aspects, the techniques described herein relate to a traction battery pack, wherein the busbar is overmolded with the polymer material.

In some aspects, the techniques described herein relate to a traction battery pack, wherein the plurality of battery cells are cylindrical battery cells.

In some aspects, the techniques described herein relate to a traction battery pack, wherein the battery cells are arranged in staggered rows.

In some aspects, the techniques described herein relate to an electrified vehicle, including: a traction battery pack, wherein the traction battery pack includes a housing, a plurality of battery cells arranged within the housing, and a busbar configured to electrically connect the battery cells, wherein the busbar is partially embedded in a polymer material so as to provide an embedded busbar, and wherein the embedded busbar establishes at least a portion of the housing.

In some aspects, the techniques described herein relate to an electrified vehicle, further including: a first layer of polymer material adjacent the battery cells; and a second layer of polymer material, wherein the busbar is arranged between the first and second layers of polymer material.

In some aspects, the techniques described herein relate to an electrified vehicle, wherein: the first layer of polymer material includes a plurality of openings, the busbar includes a plurality of nodes, each of the nodes is configured to project through one of the openings to electrically couple to one of the battery cells.

In some aspects, the techniques described herein relate to an electrified vehicle, wherein the polymer material is overmolded relative to the busbar.

In some aspects, the techniques described herein relate to a method, including: at least partially embedding a busbar of a traction battery pack of an electrified vehicle within a polymer material.

In some aspects, the techniques described herein relate to a method, wherein the busbar is overmolded with the polymer material.

### BRIEF DESCRIPTION OF THE DRAWINGS

FIG. 1 schematically illustrates an electrified vehicle.

FIG. 2 illustrates a plurality of cylindrical battery cells relative to an electrified vehicle.

FIG. 3 is an expanded view of a traction battery pack.

FIG. 4 is a perspective view of the traction battery pack of FIG. 3, with a top wall of the traction battery pack removed.

FIG. 5 is a perspective, exploded view of another battery pack, including a housing with a top tray.

FIG. 6 is a perspective, exploded view of another battery pack, including a housing with a bottom tray.

FIG. 7 somewhat schematically illustrates an arrangement of an embedded busbar relative to a battery cell.

FIG. 8 somewhat schematically illustrates another arrangement of an embedded busbar relative to a battery cell.

FIG. 9 is a view of a portion of an example busbar.

FIG. 10 illustrates another arrangement of an embedded busbar relative to a battery cell.

FIG. 11 illustrates an arrangement of an embedded busbar adjacent the perimeter.

FIG. 12 illustrates a terminal of an embedded busbar.

### DETAILED DESCRIPTION

This disclosure relates generally to a busbar module for a traction battery pack of an electrified vehicle. Among other benefits, which will be appreciated from the description below, this disclosure provides a battery pack with a single, integrated structure containing a number of components including, as examples, a cover plate, a busbar, a sensing circuit, etc. This arrangement facilitates heat transfer relative to the busbar and sensing circuit, if present, while also effectively sealing the busbar and sensing circuit relative to thermal exchange fluid. These and other benefits will be appreciated from the below.

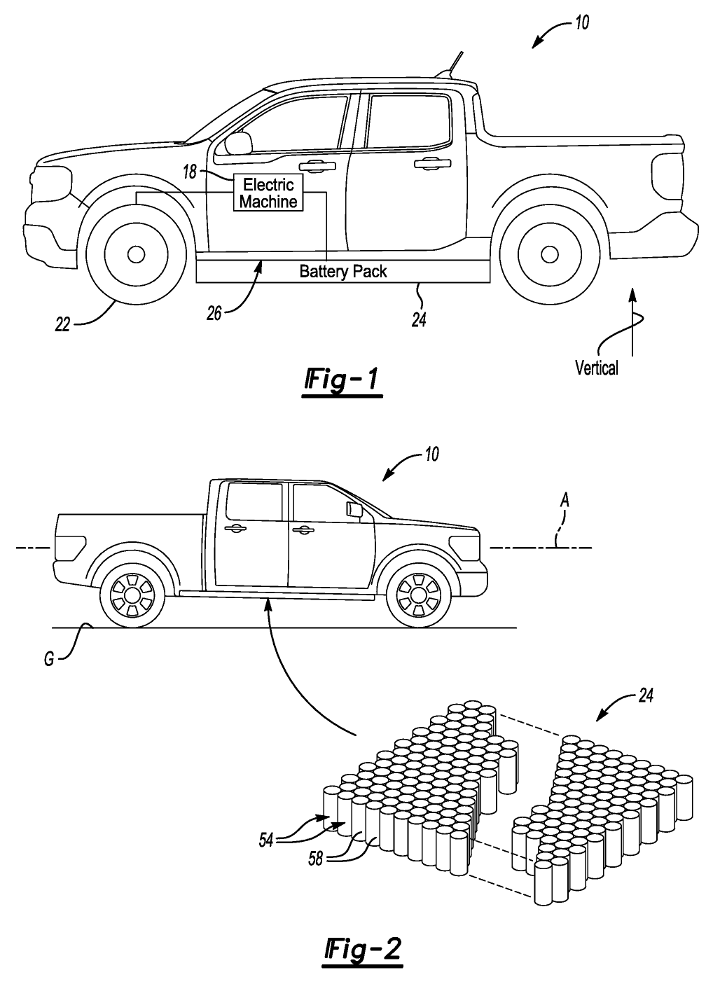

With reference to FIG. 1, an electrified vehicle 10 includes a battery pack 24, an electric machine 18, and wheels 22. The battery pack 24 powers the electric machine 18, which can convert electrical power to mechanical power to drive the wheels 22. The battery pack 24 is thus a traction battery pack.

The battery pack 24 is, in the exemplary embodiment, secured to an underbody 26 of the electrified vehicle 10. The battery pack 24 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIGS. 2-4, the battery pack 24 includes a plurality of individual battery cells 54. The battery cells 54 each include an outer case 58. The outer cases 58 can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

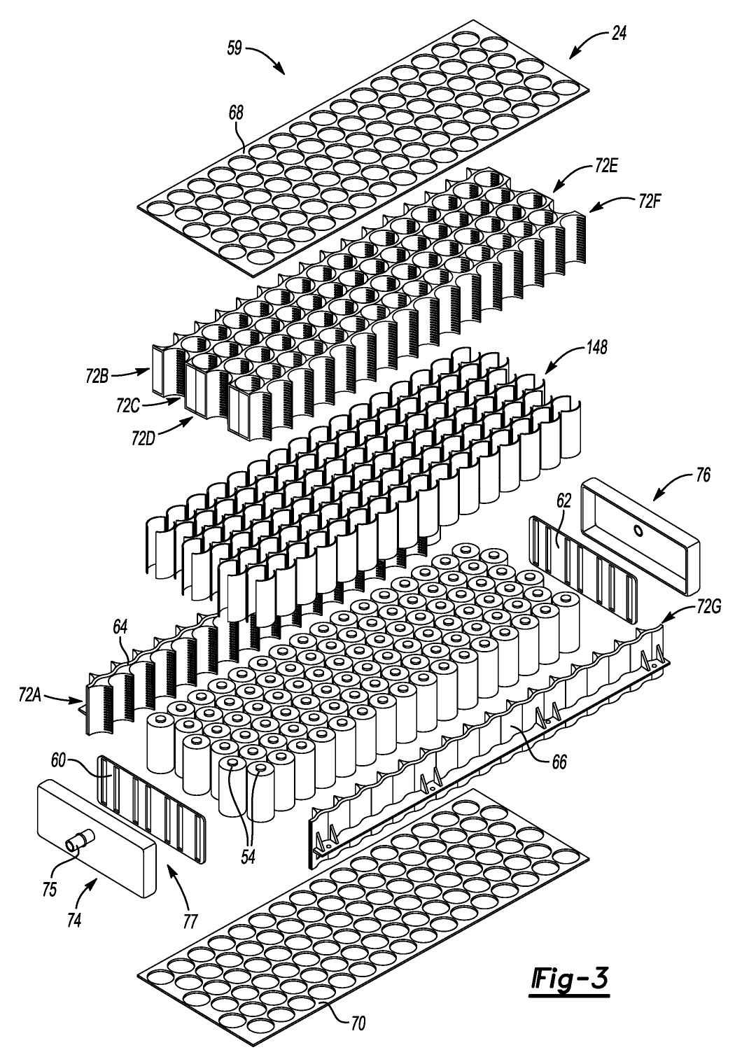

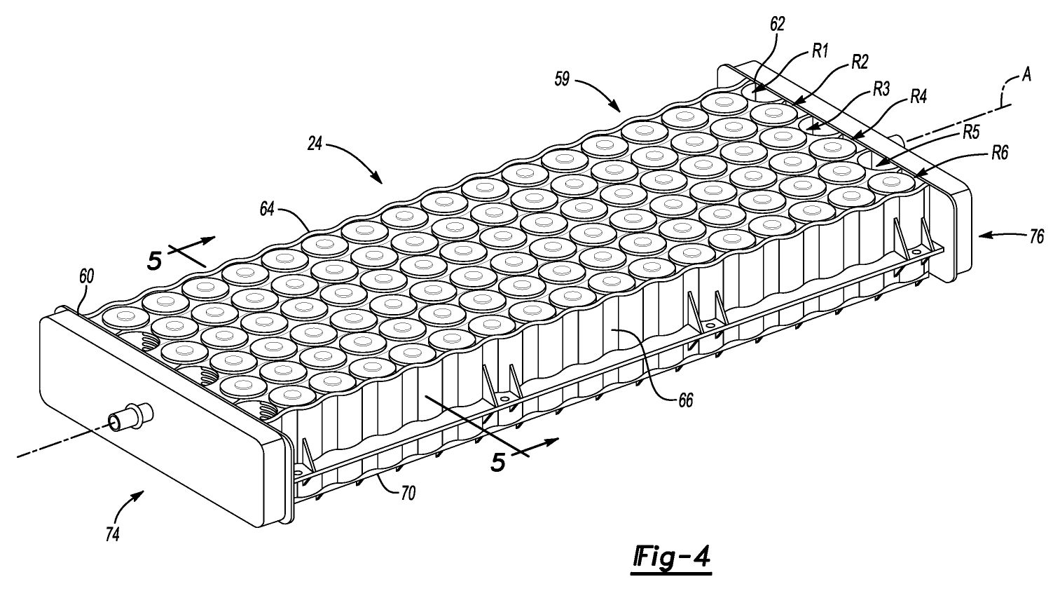

With specific reference to FIGS. 3 and 4, the battery pack 24 includes a housing 59 established by a first end wall 60, a second end wall 62 arranged on an opposite side of the battery pack 24 as the first end wall 60, a first side wall 64 extending along a first side of the battery pack 24 between the first and second end walls 60, 62, and a second side wall 66 extending between the first and second end walls 60, 62 along a second side of the battery pack 24 opposite the first side wall 64. The battery pack 24 further includes a top wall 68 and a bottom wall 70. The top wall 68 is removed in FIG. 4 for ease of viewing the arrangement of battery cells 54.

As shown in FIG. 4, the battery cells 54 are arranged in groups, which here are rows R1-R6. Rows R1-R6 extend generally from first end wall 60 to second end wall 62. While there are six rows R1-R6 in this example, this disclosure extends to battery packs with a different number of rows. Further, this disclosure is not limited to the particular number battery cells 54 in a particular row.

Rows R1-R6 are each generally parallel to one another and, optionally, to a longitudinal axis A of the vehicle 56, in this example. Adjacent rows R1-R6 are staggered relative to one another to enable closer packaging of the battery cells 54, which results in the battery cells 54 having a generally honeycomb pattern. In this example, the battery cells 54 are arranged such that the electrical connections between adjacent battery cells 54 are made adjacent the top wall 68, and a venting arrangement is arranged adjacent bottom wall 70.

The battery pack 24 includes a plurality of fluid conduits 72A-72G, each of which is configured to direct thermal exchange fluid, such as coolant, water, etc., therein to transfer thermal energy between the thermal exchange fluid and the battery cells 54. In a particular example, the thermal exchange fluid is configured to absorb heat from the battery cells 54. Each of the fluid conduits 72A-72G individually, or a group of some or all of the fluid conduits 72A-72G collectively, may be referred to as a cooling jacket.

The fluid conduits 72A-72G are arranged relative to manifold assemblies 74, 76 to facilitate a flow of thermal exchange fluid relative to the fluid conduits 72A-72G. With reference to manifold assembly 74, each manifold assembly 74, 76 includes an inlet 75 and a plenum 77 between inlet 75 and end wall 60. End wall 60 includes a plurality of slots configured to direct thermal exchange fluid from plenum 77 into fluid conduits 72A-72G or receive fluid expelled from fluid conduits 72A-72G. While two manifold assemblies 74, 76 are shown in FIGS. 3 and 4, this disclosure extends to examples with one or more manifold assemblies. The manifold assembly or assemblies may enable flow of thermal exchange fluid within the fluid conduits 72A-72G in series or in parallel, as examples.

The manifold assemblies 74, 76 and fluid conduits 72A-72G enable transfer of thermal energy between the thermal exchange fluid and the battery cells 54 without directly bringing the thermal exchange fluid into contact with the battery cells 54. In this regard, the manifold assemblies 74, 76 and fluid conduits 72A-72G may be considered hermetically sealed.

The fluid conduits 72A-72G are made of polymer, and in a particular example are made entirely of polymer. The fluid conduits 72A-72G can therefore be relatively easily manufactured using known techniques, such as injection molding. The fluid conduits 72A-72G exhibit relatively high strength and heat transfer properties. The fluid conduits 72A-72G are also relatively light weight.

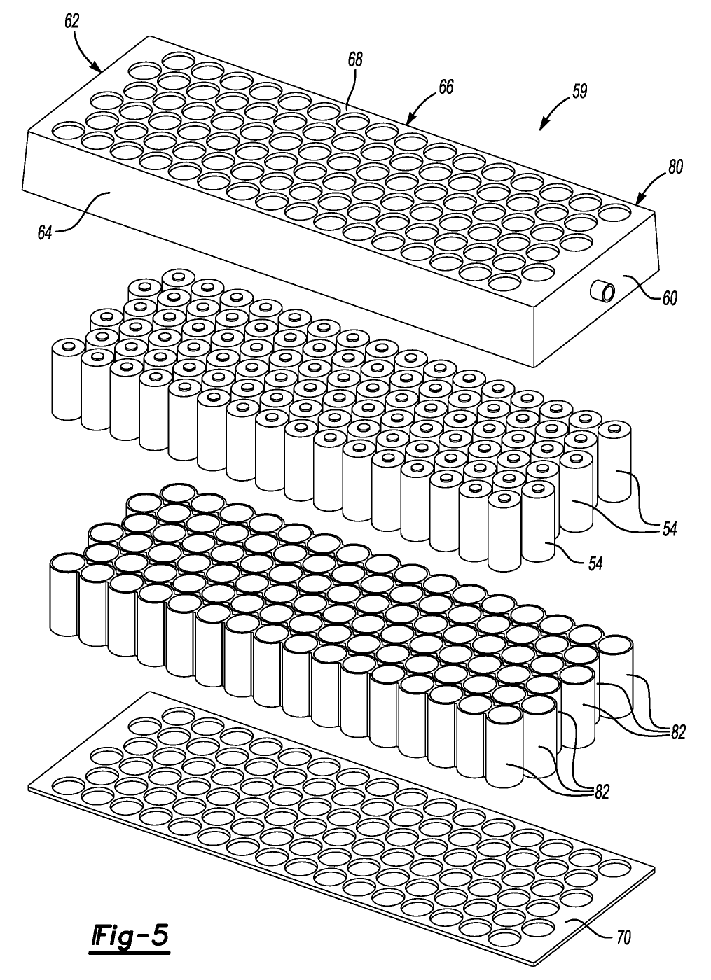

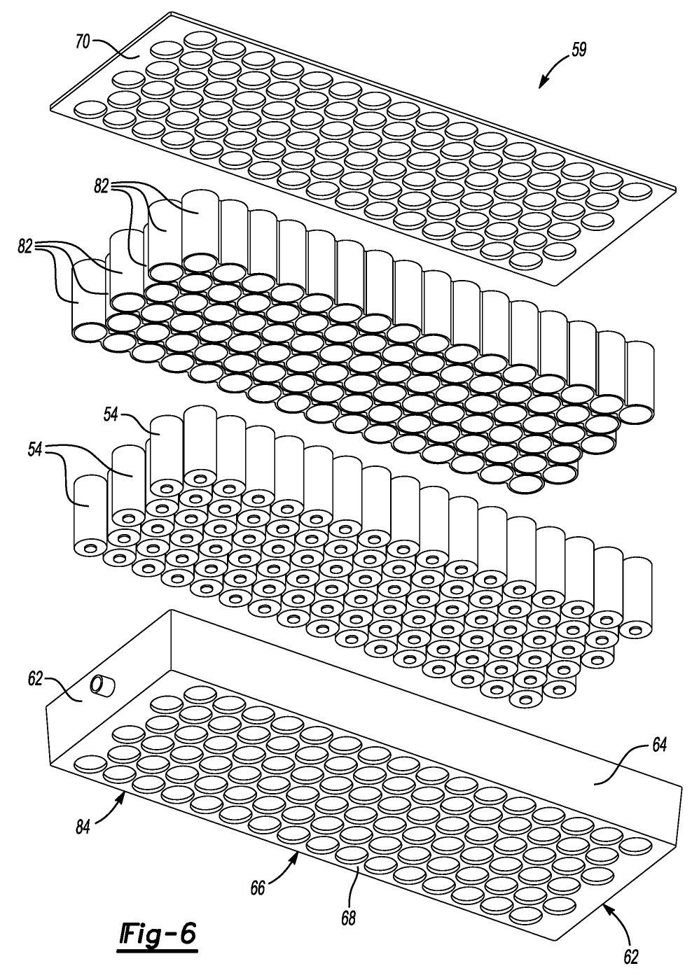

Alternative configurations of the housing 59 are shown relative to FIGS. 5 and 6. With reference to FIG. 5, a top tray 80 establishes five sides of the housing 59, namely end walls 60, 62, side walls 64, 66, and top wall 68. Bottom wall 70 is provided separately and is attached to the top tray 80. In this example, each of the battery cells 54 is arranged within a corresponding sleeve 82. Each of the sleeves 82 is configured to directly contact bottom wall 70 and top wall 68. In the embodiment of FIG. 6, a bottom tray 84 establishes five sides of the housing 59, namely end walls 60, 62, side walls 64, 66, and bottom wall 70. Top wall 68 is provided separately and is attached to the bottom tray 84. In both embodiments, the sleeves 82 completely surround a battery cell 54 and directly contact the top and bottom walls 68, 70, thereby preventing direct contact with any thermal exchange fluid that flows within the housings 59 of FIGS. 5 and 6. In an aspect of this disclosure, thermal exchange fluid is permitted to flow within the housing 59, in the spaces between sleeves 82, to exchange thermal energy with the battery cells 54.

In this disclosure, a busbar establishing at least cell-to-cell connections (e.g., electrical connections between battery cells 54) is at least partially embedded into a polymer material, and that embedded structure, which may be referred to as an embedded busbar, establishes at least a portion of housing 59. In a particular example, the embedded busbar establishes the top wall 68. In another example, the embedded busbar establishes the bottom wall 70. In yet another example, the embedded busbar establishes a portion of top tray 80 or bottom tray 84.

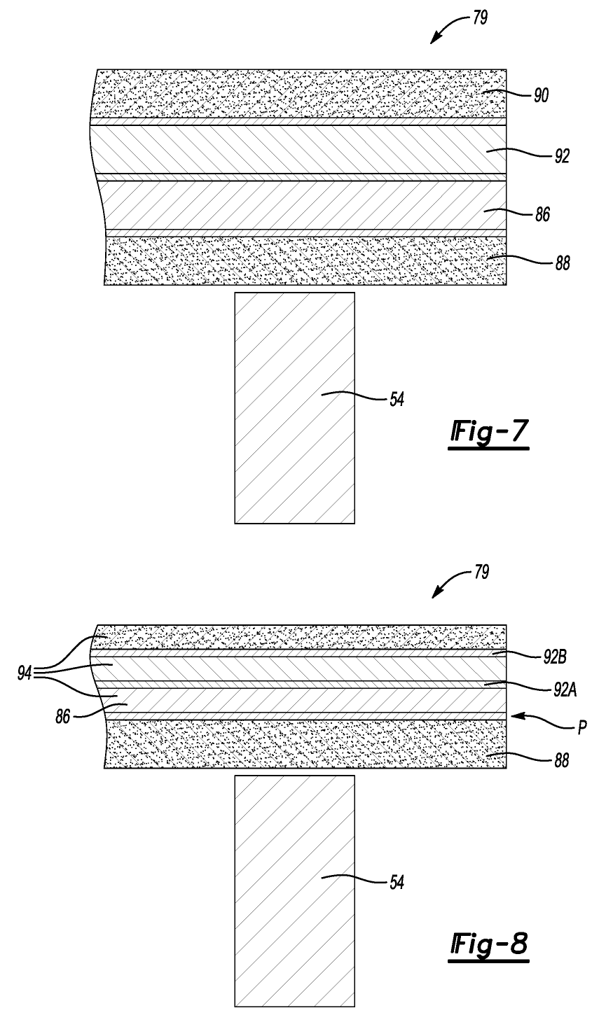

FIG. 7 illustrates a first embedded busbar 79. In this embodiment, a busbar 86 is at least partially embedded into a polymer material. In this example, a first layer of polymer material 88 is arranged generally between the busbar 86 and the battery cells 54 (only one of which is shown). Further, in this example, a second layer of polymer material 90 is arranged on an opposite side of the busbar 86 as the first layer of polymer material 88. The second layer of polymer material 90 is not required in all examples. Further, the first and second layers of polymer material 88, 90 could be provided by a single, integrated layer of polymer material.

The first layer of polymer material 88 and, when present, the second layer of polymer material 90 may be formed by overmolding. In this regard, busbar 86 may be considered to be at least partially overmolded with polymer material.

In addition to the busbar 86, one ore more additional electronic components of the battery pack 24 may be embedded within the same polymer material as the busbar 86. In this example, a sensing circuit 92 configured to sense voltages of the cells 54 is arranged between busbar 86 and the second layer of polymer material 90. The sensing circuit 92 may also be considered to be at least partially overmolded with polymer material. The sensing circuit 92 is not required in all examples. When the busbar 86 and, if present, the sensing circuit 92 are overmolded, the overmolding process adheres the polymer material to the busbar 86 and sensing circuit 92 without the need for a separate adhesive. The sensing circuit 92 may not be embedded with the busbar, in other examples.

An alternative configuration of the embedded busbar 79 is shown in FIG. 8. In FIG. 8, the busbar 86 is at least partially embedded into the first layer of polymer material 88, similar to the embodiment of FIG. 7. In this example, a plurality of insulating sheets 94 are arranged on an opposite side of the busbar 86 as the first layer of polymer material 88, and two flex circuits 92A, 92B are sandwiched between adjacent insulating sheets 94. Each flex circuit 92A, 92B may be a voltage sensing circuit or some other type of circuit. The flex circuits may be flexible printed circuits (FPCs). The insulating sheets 94 may be made of polymer, and may be overmolded relative to the busbar 86 and/or the flex circuits 92A, 92B. Alternatively, the insulating sheets 94 and flex circuits 92A, 92B may be welded or adhered to one another and to the busbar 86, in an example.

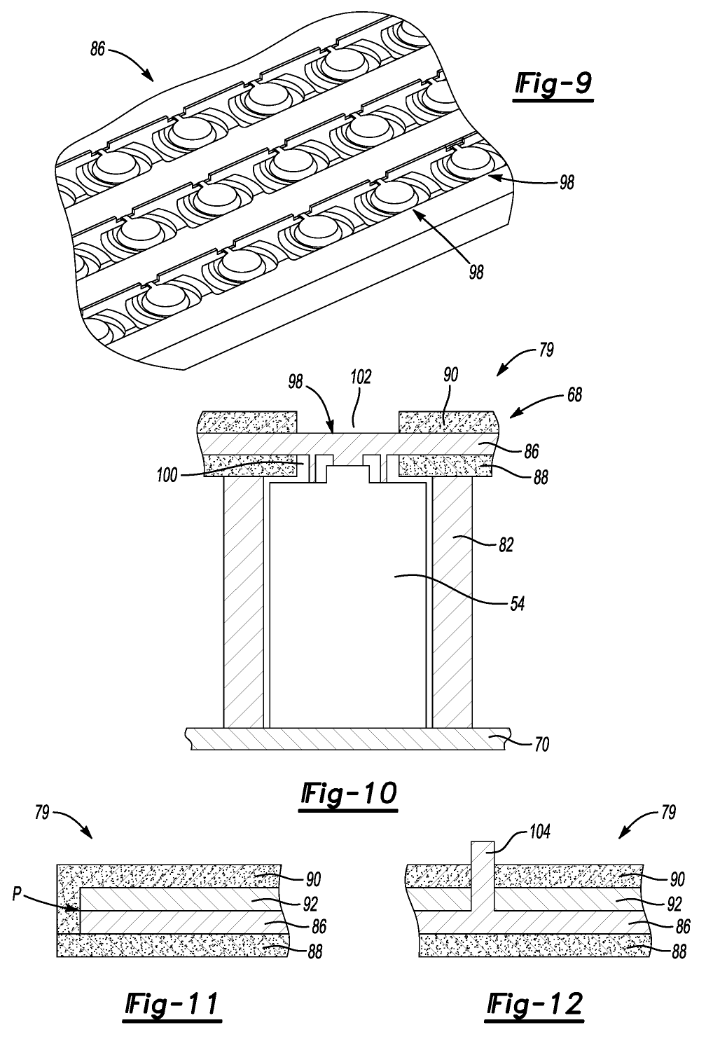

The busbar 86 is shown without the layers of polymer material or the sensing circuits in FIG. 9. The busbar 86 includes a plurality of nodes 98, each of which is configured to electrically couple to one of the battery cells 54. The nodes 98 are each configured to establish at least one connection to a positive terminal and at least one connection to a negative terminal relative to each battery cell 54. In a particular embodiment, each node 98 is configured to establish two connections to a positive terminal and two connections to a negative terminal relative to each battery cell 54.

In order to facilitate direct contact between the cells 54 and the nodes 98, the first layer of polymer material 88 may include a plurality of openings 100 configured to permit the nodes 98 to directly contact the cells 54, as shown in FIG. 10. Alternatively, nodes 98 may at least partially project through a bottom-most surface of the first layer of polymer material 88.

FIG. 10 illustrates an example arrangement of an embedded busbar 79 relative to an exemplary cell 54. In the embodiment of FIG. 10, there is a busbar 86 embedded between first and second layers of polymer material 88, 90, without a sensing circuit. The embedded busbar 79 of FIG. 10 establishes the top wall 68 of housing 59 in this example. As shown, cell 54 is arranged within sleeve 82, which directly contacts top and bottom walls 68, 70, and in particular directly contacts the first layer of polymer material 88 to form a fluid-tight barrier. As such, despite the openings 100, thermal exchange fluid is prevented from coming into contact with busbar 86. In the embodiment of FIGS. 3-4, the fluid conduits 72A-72G are closed and prevent thermal exchange fluid from contacting the busbar 86.

In this embodiment, the second layer of polymer material 90 includes openings 102, each of which is aligned with one of the nodes 98 and a corresponding opening 100. The openings 102 may facilitate welding of the nodes 98 to the cells 54.

In an embodiment, the embedded busbar 79 is configured such that the first and second layers of polymer material 88, 90 directly contact one another outside a perimeter P (FIG. 11) of the busbar 86 to establish a fluid-tight seal adjacent the perimeter P of the busbar 86. In this regard, the first and second layers 88, 90 of polymer material may be provided in a single overmolding process, and may not exhibit any joints or seams. Alternatively, as shown in FIG. 8, a perimeter P of the busbar 86 may be uncovered by polymer material.

In an embodiment, shown in FIG. 12, the busbar 86 is connectable to components other than the battery cells 54 via a terminals 104. In this embodiment, a terminal 104 of busbar 86 projects through the second layer of polymer material 90. Terminal 104 may be a structure of the busbar 86 or may be another structure configured to couple to the busbar 86. The terminal 104 may be a raised portion of the busbar 86, in some examples.

It should be understood that terms such as “about,” “substantially,” and “generally” are not intended to be boundaryless terms, and should be interpreted consistent with the way one skilled in the art would interpret those terms. Directional terms should be interpreted consistent with the context that those terms are used.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack, comprising:
a housing;
a plurality of battery cells arranged within the housing; and
a busbar configured to electrically connect the battery cells, wherein the busbar is partially embedded in a polymer material so as to provide an embedded busbar, and wherein the embedded busbar establishes at least a portion of the housing.

1. The traction battery pack as recited in claim 1, further comprising:
a first layer of polymer material adjacent the battery cells; and
a second layer of polymer material, wherein the busbar is arranged between the first and second layers of polymer material.

2. The traction battery pack as recited in claim 2, further comprising:
a sensing circuit, wherein the sensing circuit is also arranged between the first and second layers of polymer material.

3. The traction battery pack as recited in claim 3, wherein the sensing circuit is configured to sense a voltage of the battery cells.

4. The traction battery pack as recited in claim 3, wherein the sensing circuit is arranged between the busbar and the second layer of polymer material.

5. The traction battery pack as recited in claim 2, wherein:
the first layer of polymer material includes a plurality of openings,
the busbar includes a plurality of nodes, and
each of the nodes is configured to project through one of the openings to electrically couple to one of the battery cells.

6. The traction battery pack as recited in claim 6, wherein the second layer of polymer material includes a plurality of openings aligned with the nodes to facilitate welding of the nodes to a corresponding one of the battery cells.

7. The traction battery pack as recited in claim 6, wherein:
a terminal of the busbar projects through the second polymer layer.

8. The traction battery pack as recited in claim 2, wherein the first and second layers of polymer material directly contact one another outside a perimeter of the busbar to establish a fluid-tight seal adjacent the perimeter of the busbar.

9. The traction battery pack as recited in claim 1, further comprising:
a fluid conduit arranged adjacent the battery cells, wherein the fluid conduit defines a passageway configured to guide thermal exchange fluid relative to the battery cells and prevents the thermal exchange fluid from coming into contact with the busbar.

10. The traction battery pack as recited in claim 1, further comprising:
a plurality of sleeves, wherein each battery cell is arranged within one of the sleeves, and wherein the polymer material is coupled to the each of the sleeves so as to establish a plurality of fluid-tight barriers between thermal exchange fluid and the busbar.

11. The traction battery pack as recited in claim 1, wherein the busbar is overmolded with the polymer material.

12. The traction battery pack as recited in claim 1, wherein the plurality of battery cells are cylindrical battery cells.

13. The traction battery pack as recited in claim 13, wherein the battery cells are arranged in staggered rows.

14. An electrified vehicle, comprising:
a traction battery pack, wherein the traction battery pack comprises a housing, a plurality of battery cells arranged within the housing, and a busbar configured to electrically connect the battery cells, wherein the busbar is partially embedded in a polymer material so as to provide an embedded busbar, and wherein the embedded busbar establishes at least a portion of the housing.

15. The electrified vehicle as recited in claim 15, further comprising:
a first layer of polymer material adjacent the battery cells; and
a second layer of polymer material, wherein the busbar is arranged between the first and second layers of polymer material.

16. The electrified vehicle as recited in claim 16, wherein:
the first layer of polymer material includes a plurality of openings,
the busbar includes a plurality of nodes,
each of the nodes is configured to project through one of the openings to electrically couple to one of the battery cells.

17. The electrified vehicle as recited in claim 15, wherein the polymer material is overmolded relative to the busbar.

18. A method, comprising:
at least partially embedding a busbar of a traction battery pack of an electrified vehicle within a polymer material.

19. The method as recited in claim 19, wherein the busbar is overmolded with the polymer material.
